(19) United States
(12) Patent Application Publication
(10) Pub. No.: US 2015/0380151 A1
(43) Pub. Date: Dec. 31, 2015

(54) CHIP COIL COMPONENT AND METHOD OF MANUFACTURING THE SAME

(71) Applicant: Samsung Electro-Mechanics Co., Ltd., Suwon-Si (KR)

(72) Inventor: Min Sung CHOI, Suwon-Si (KR)

(73) Assignee: SAMSUNG ELECTRO-MECHANICS CO., LTD.

(21) Appl. No.: 14/485,444

(22) Filed: Sep. 12, 2014

(30) Foreign Application Priority Data
Jun. 25, 2014 (KR) 10-2014-0077868

(51) Int. Cl. H01F 27/28; H01F 41/04

(52) U.S. Cl. CPC H01F 27/2804; H01F 41/041; H01F 2027/2809

(57) ABSTRACT

A chip coil component may include: a ceramic body including a plurality of insulating layers and having a bottom surface provided as a mounting surface and a top surface opposing the bottom surface, an internal coil part disposed in the ceramic body and having first and second lead-out portions exposed to both end surfaces of the ceramic body in a length direction thereof, an external electrode disposed on the bottom surface of the ceramic body, and plating spreading parts formed on both end surfaces of the ceramic body in the length direction and connecting the first and second lead-out portions and the external electrode to each other.

### CROSS-REFERENCE TO RELATED APPLICATION

This application claims the benefit of Korean Patent Application No. 10-2014-0077868 filed on Jun. 25, 2014, with the Korean Intellectual Property Office, the disclosure of which is incorporated herein by reference.

### BACKGROUND

The present disclosure relates to a chip coil component and a method of manufacturing the same.

An inductor, a multilayer chip component, is a representative passive element forming an electronic circuit together with a resistor and a capacitor to remove noise or to be used as a component forming an LC resonance circuit.

Meanwhile, a multilayer inductor has been recently widely used, where the multilayer inductor has a structure in which a plurality of magnetic layers or dielectric layers having internal coil patterns formed therein are stacked and the internal coil patterns are connected to each other to form a coil structure, thereby implementing characteristics of inductance, impedance, and the like to be targeted.

The multilayer inductor has been developed to achieve miniaturization, a high level of current and a low level of direct current resistance (Rdc).

In addition, when a metal can is formed to remove radiating noise after the multilayer inductor is mounted on a board, short circuits may occur by contact between the metal can and an external electrode of the multilayer inductor.

### RELATED ART DOCUMENT

Japanese Patent Laid-Open Publication No. 2010-165973

### SUMMARY

An exemplary embodiment in the present disclosure may provide a chip coil component in which lead-out portions of internal coil patterns exposed to both end surfaces of a body in a length direction thereof are connected to external electrodes formed on a bottom surface of the body through plating spreading properties, so as to prevent the occurrence of short circuits due to contact between a metal can and an external electrode of a multilayer inductor, and a method of manufacturing the same.

According to an exemplary embodiment in the present disclosure, a chip coil component may include: a ceramic body including a plurality of insulating layers and having a bottom surface provided as a mounting surface and a top surface opposing the bottom surface; an internal coil part disposed in the ceramic body and having first and second lead-out portions exposed to both end surfaces of the ceramic body in a length direction of the ceramic body; an external electrode disposed on the bottom surface of the ceramic body; and plating spreading parts formed on both end surfaces of the ceramic body in the length direction of the ceramic body and connecting the first and second lead-out portions and the external electrode to each other.

According to an exemplary embodiment in the present disclosure, a method of manufacturing a chip coil component may include: preparing insulating sheets; forming internal coil patterns on the insulating sheets; forming a ceramic body including an internal coil part having a first lead-out portion and a second lead-out portion exposed to both end surfaces of the ceramic body in a length direction of the ceramic body by stacking the insulating sheets on which the internal coil patterns are formed and having a bottom surface provided as a mounting surface and a top surface opposing the bottom surface; forming an external electrode on the bottom surface of the ceramic body; and connecting the first and second lead-out portions and the external electrode to each other by plating.

### BRIEF DESCRIPTION OF THE DRAWINGS

The above and other aspects, features and other advantages will be more clearly understood from the following detailed description taken in conjunction with the accompanying drawings, in which:

FIG. 1 is a perspective view illustrating a chip coil component according to an exemplary embodiment in the present disclosure, in which an internal coil part of the chip coil component is viewed;

FIG. 2 is a view illustrating a cross section taken in a length-thickness direction of the chip coil component shown in FIG. 1;

FIG. 3 is a perspective view illustrating the chip coil component of FIG. 1 in further detail;

FIG. 4 is a view illustrating a form in which an insulating layer is added to the cross-sectional view shown in FIG. 2;

FIG. 5A is a view illustrating a top surface of a chip coil component according to an exemplary embodiment in the present disclosure;

FIG. 5B is a view illustrating a bottom surface (mounting surface) of a chip coil component according to an exemplary embodiment in the present disclosure;

FIG. 5C is a view illustrating one side surface of a chip coil component in a width direction thereof according to an exemplary embodiment in the present disclosure;

FIG. 5D is a view illustrating one end surface of a chip coil component in a length direction thereof according to an exemplary embodiment in the present disclosure;

FIGS. 6A through 6F are views illustrating a method of manufacturing a chip coil component according to an exemplary embodiment in the present disclosure; and

FIG. 7 is a flow chart illustrating the method of manufacturing a chip coil component according to an exemplary embodiment in the present disclosure.

### DETAILED DESCRIPTION

Exemplary embodiments in the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Chip Coil Component

Hereinafter, a multilayer electronic component according to an exemplary embodiment in the present disclosure, in detail, a multilayer inductor will be described. However, the present disclosure is not limited thereto. For example, the multilayer electronic component according to an exemplary embodiment in the present disclosure may be configured by an inductor using a metal, for example, a thin film type inductor.

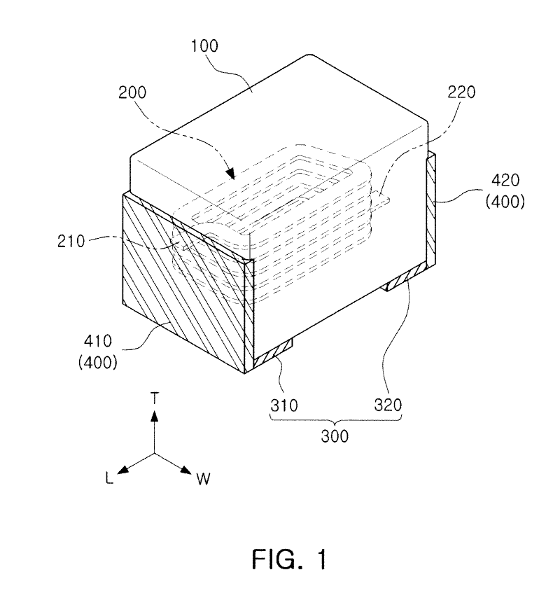

FIG. 1 is a perspective view illustrating a chip coil component according to an exemplary embodiment in the present disclosure, in which an internal coil part of the chip coil component is shown.

Referring to FIG. 1, the chip coil component according to an exemplary embodiment in the present disclosure may include a ceramic body 100, an internal coil part 200, an external electrode 300, and a plating spreading part 400.

The ceramic body 100 may include a plurality of insulating layers. In this case, the ceramic body 100 may be in a state in which the plurality of insulating layers are sintered. The insulating layers adjacent to each other may be integrated with each other so as not to confirm a boundary therebetween without using a scanning electron microscope (SEM).

The ceramic body 100 may have a hexahedral shape. A direction of the hexahedron will be defined in order to clearly describe an exemplary embodiment in the present disclosure. L, W and T shown in FIG. 1 refer to a length direction, a width direction, and a thickness direction, respectively. In addition, the ceramic body 100 may have a bottom surface provided as a mounting surface, a top surface opposing the bottom surface, both end surfaces in a length direction, and both side surfaces in a width direction.

The plurality of insulating layers may include commonly known ferrite such as Mn—Zn based ferrite, Ni—Zn based ferrite, Ni—Zn—Cu based ferrite, Mn—Mg based ferrite, Ba based ferrite, Li based ferrite, or the like.

The internal coil part 200 may be disposed in the ceramic body 100 and may include first and second lead-out portions 210 and 220 exposed outwardly of the ceramic body 100. In further detail, the first and second lead-out portions 210 and 220 correspond to one portion of the internal coil part 200 and may be exposed to both end surfaces of the ceramic body 100 in the length direction thereof.

The internal coil part 200 may be formed by printing a conductive paste containing a conductive metal. The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

The external electrode 300 may be disposed on the bottom surface of the ceramic body 100. For example, the external electrode 300 may include first and second external electrodes 310 and 320 and the first and second external electrodes 310 and 320 may respectively be disposed on the bottom surface of the ceramic body 100. Meanwhile, the first and second external electrode 310 and 320 may be disposed in a state in which they are spaced apart from each other by a predetermined distance. Hereinafter, a common configuration of the first and second external electrodes 310 and 320 will be described as a configuration of the external electrode 300.

The external electrode 300 may be formed using a metal having excellent electrical conductivity, for example, nickel (Ni), copper (Cu), tin (Sn), or silver (Ag), alone, or an alloy thereof.

The plating spreading part 400 may be formed on both end surfaces of the ceramic body 100 in the length direction thereof.

In further detail, the plating spreading part 400 may include a first plating spreading portion 410 electrically connected to the first lead-out portion 210 and a second plating spreading portion 420 electrically connected to the second lead-out portion 220. Hereinafter, common configurations of the first and second plating spreading portions 410 and 420 will be described as a configuration of the plating spreading part 400.

The first plating spreading portion 410 may be formed so that the first lead-out portion 210 and the first external electrode 310 may be electrically connected to each other by plating and the second plating spreading portion 420 may be formed so that the second lead-out portion 220 and the second external electrode 320 may be electrically connected to each other by plating.

In this case, a plating material may be a conductive material and may be one of silver (Ag), palladium (Pd), aluminum (Al), nickel (Ni), titanium (Ti), gold (Au), copper (Cu), platinum (Pt), and the like, or a mixture thereof.

Meanwhile, a length of the plating spreading part 400 in a thickness direction may be longer than a length from the bottom surface of the ceramic body 100 to the first or second lead-out portion 210 or 220 and may be shorter than a thickness of the ceramic body 100 in the thickness direction thereof.

In addition, although FIG. 1 illustrates a case in which lengths of the first and second plating spreading portions 410 and 420 in the thickness direction are the same as each other, the lengths are not necessarily the same as each other. For example, depending on positions to which the first and second lead-out portions 210 and 220 are exposed on both end surfaces of the ceramic body 100 in the length direction thereof, the lengths of the first and second plating spreading portions 410 and 420 in the thickness direction may be changed.

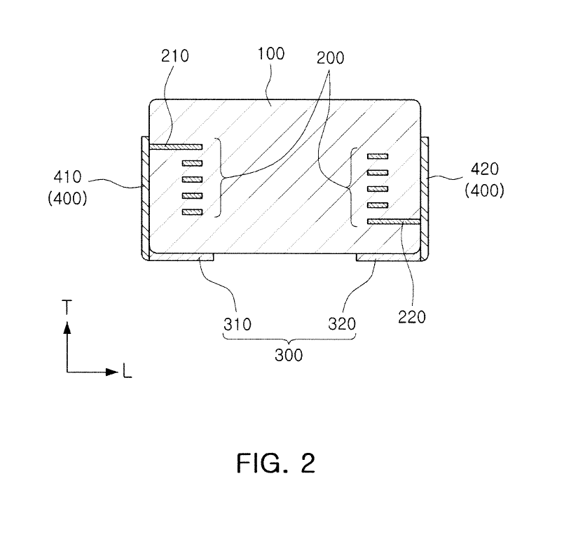

FIG. 2 is a view illustrating a cross section taken in a length-thickness direction of the chip coil component shown in FIG. 1.

Referring to FIG. 2, the ceramic body 100 may be formed by stacking the plurality of insulating layers on which the internal coil patterns are formed, on each other. In this case, the internal coil patterns formed on the plurality of insulating layers may be electrically connected to each other by via electrodes and may be stacked in a stacking direction in which the plurality of insulating layers are stacked in the ceramic body to thereby form a spiral internal coil part 200 therein.

The plating spreading part 400 may be formed on both end surfaces of the ceramic body 100 in the length direction thereof, as illustrated in FIG. 1, and may electrically connect the first and second lead-out portions 210 and 220 and the first and second external electrodes 310 and 320 to each other, respectively.

In this case, in the chip coil component according to an exemplary embodiment in the present disclosure, as the external electrode 300 is formed on the bottom surface of the ceramic body 100 and the plating spreading part 400 electrically connected to the external electrode 300 is formed on both end surfaces of the ceramic body 100 in the length direction thereof, the external electrode or the plating spreading part may not be formed on the top surface of the ceramic body 100.

As a result, after the chip coil component according to an exemplary embodiment in the present disclosure is mounted on the board, short circuits due to a metal can which is formed on the top surface to remove radiating noise may be prevented.

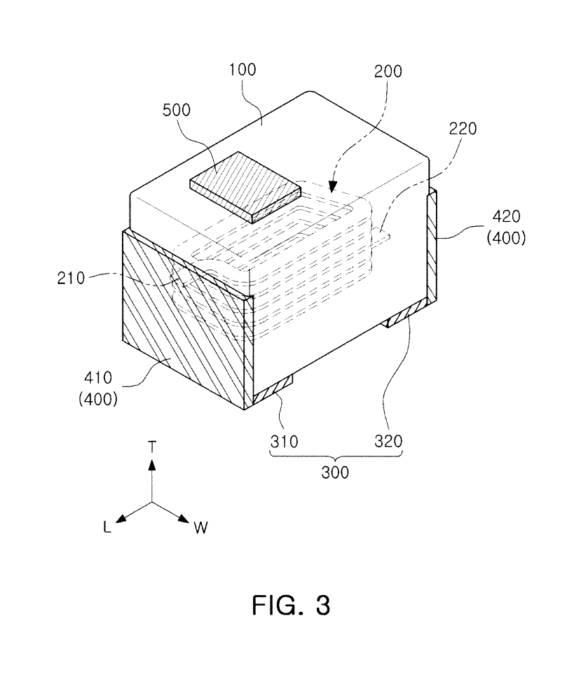

FIG. 3 is a perspective view illustrating the chip coil component of FIG. 1 in further detail.

Referring to FIG. 3, the chip coil component according to an exemplary embodiment in the present disclosure may further include a marking pattern 500 formed on the top surface of the ceramic body 100.

Although FIG. 3 illustrates a case in which the marking pattern 500 having a square shape is positioned on a portion of the top surface of the ceramic body 100, the shape and position of the marking pattern 500 are not limited to those shown in FIG. 3.

The marking pattern 500, which is to identify surfaces to which the first and second lead-out portions 210 and 220 are exposed and on which the first and second plating spreading portions 400 need to be formed, may be formed on the top surface of the ceramic body 100 as shown in FIG. 3. In addition, since the position of the marking pattern 500 is not particularly limited as described above, the marking pattern 500 may be formed on the bottom surface of the ceramic body 100.

For example, the marking patterns 500 may be formed on one surface parallel to a mounting surface of the ceramic body 100.

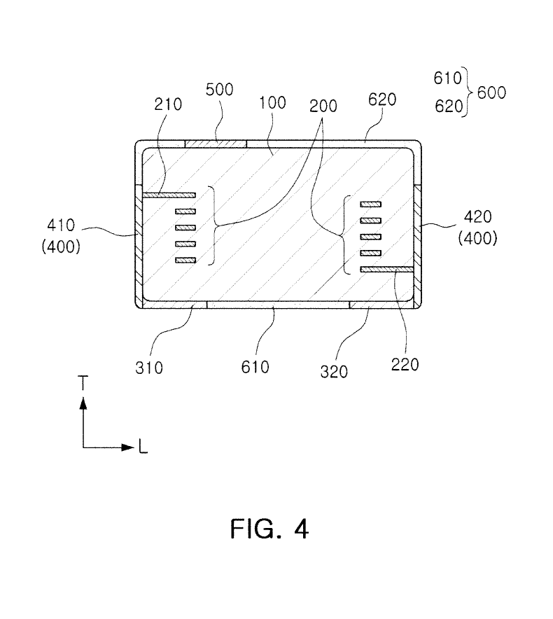

FIG. 4 is a view illustrating a form in which an insulating layer 600 is added to the cross-sectional view shown in FIG. 2.

Referring to FIG. 4, the chip coil component according to an exemplary embodiment in the present disclosure may further include the insulating layer 600 disposed on regions in which the external electrode 300 and the plating spreading part 400 are not formed on the ceramic body 100.

In further detail, an insulating layer 610 may be formed on a region in which the first and second external electrodes 310 and 320 are not formed on the bottom surface of the ceramic body 100.

In addition, an insulating layer 620 may also be formed on the top surface of the ceramic body 100. In this case, the insulating layer 620 may be formed to identify the marking pattern 500.

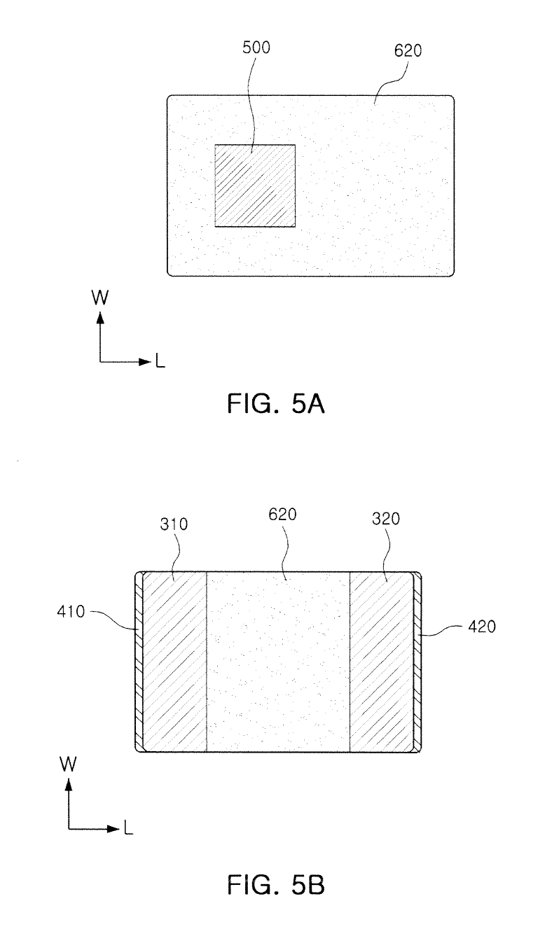

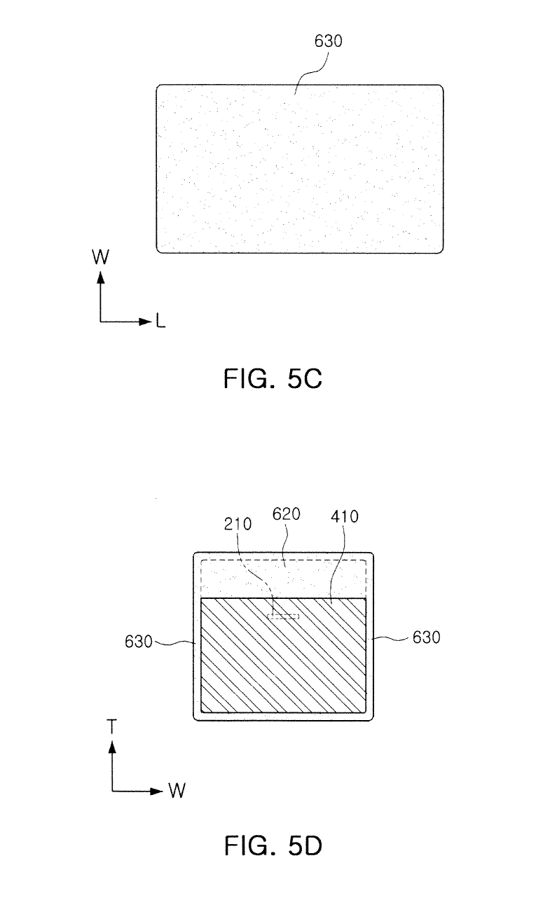

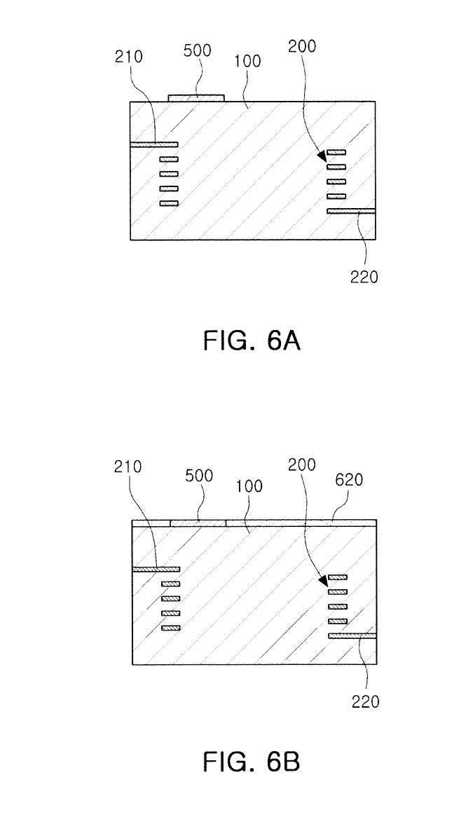

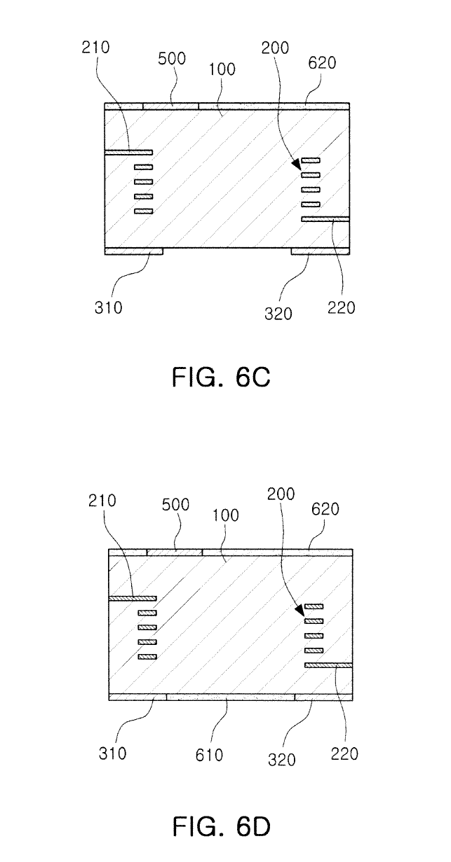

A description thereof will be provided with reference to FIGS. 5A through 5D.

FIG. 5A is a view illustrating a top surface of the chip coil component according to an exemplary embodiment in the present disclosure.

Referring to FIG. 5A, the marking pattern 500 may be formed on the top surface of the chip coil component according to an exemplary embodiment in the present disclosure, and the insulating layer 620 maybe formed on a portion thereof in which the marking pattern 500 is not formed.

FIG. 5B is a view illustrating a bottom surface (mounting surface) of the chip coil component according to an exemplary embodiment in the present disclosure.

Referring to FIG. 5B, the first and second external electrodes 310 and 320 may be formed on the bottom surface of the chip coil component according to an exemplary embodiment in the present disclosure, and the insulating layer 620 may be formed on a portion thereof in which the first and second external electrodes 310 and 320 are not formed.

FIG. 5C is a view illustrating one side of the chip coil component in a width direction thereof according to an exemplary embodiment in the present disclosure.

Referring to FIG. 5C, the insulating layer may also be formed on both side surfaces in the width direction of the ceramic body 100 in the chip coil component according to an exemplary embodiment in the present disclosure.

For example, the chip coil component according to an exemplary embodiment in the present disclosure may further include the insulating layers disposed on the regions in which the plating spreading part 400 and the external electrode 300 are not formed, whereby the plating spreading may be improved.

FIG. 5D is a view illustrating one end surface of the chip coil component in a length direction thereof according to an exemplary embodiment in the present disclosure.

Referring to FIG. 5D, the plating spreading part 400 may be formed on both end surfaces of the ceramic body 100 in the length direction thereof in the chip coil component according to an exemplary embodiment in the present disclosure, and in more detail, the first plating spreading portion 410 may be electrically connected to the first lead-out portion 210.

In this case, depending on the length of the first plating spreading portion 410 in the thickness direction, the insulating layer 620 may also be formed on both end surfaces of the ceramic body 100 in the length direction thereof.

On the other hand, in the case in which the first plating spreading portion 410 entirely cover one end surface of the ceramic body 100 in the length direction thereof, the insulating layer 620 may not be formed thereon.

Method of Manufacturing Chip Coil Component

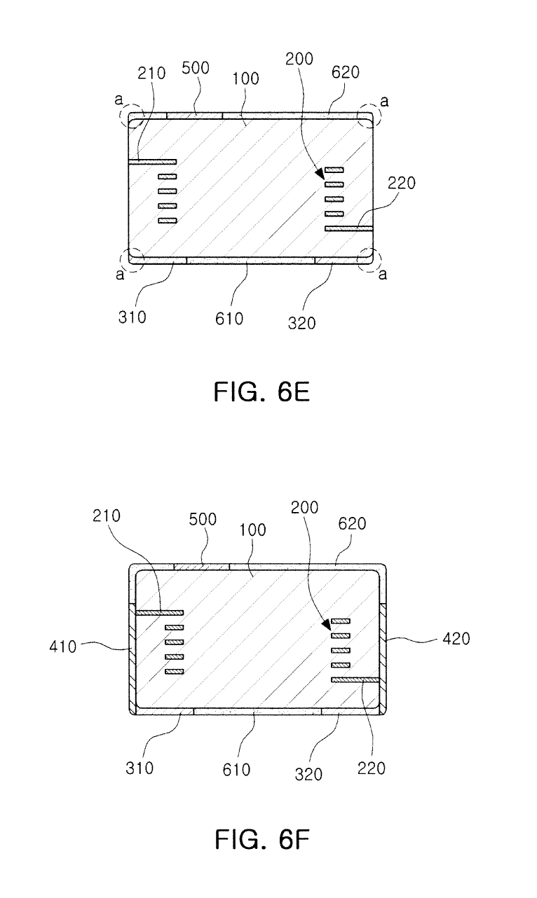

FIGS. 6A through 6F are views illustrating a method of manufacturing a chip coil component according to an exemplary embodiment in the present disclosure.

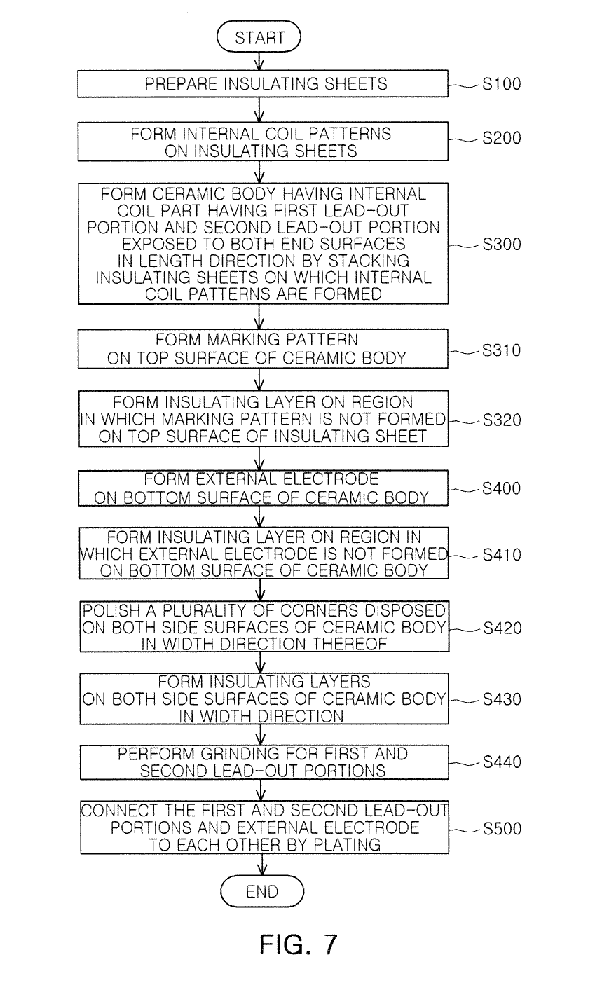

FIG. 7 is a flow chart illustrating the method of manufacturing a chip coil component according to an exemplary embodiment in the present disclosure.

Referring FIGS. 7 and 6A, a plurality of insulating sheets may be prepared (S100).

A magnetic material used to manufacture the insulating sheet is not particularly limited, but may be a commonly known ferrite powder such as a Mn—Zn-based ferrite powder, a Ni—Zn-based ferrite powder, a Ni—Zn—Cu-based ferrite powder, a Mn—Mg-based ferrite powder, a Ba-based ferrite powder, a Li-based ferrite powder, and the like.

The plurality of insulating sheets may be prepared by applying a slurry formed by mixing the magnetic material and an organic material with each other to a carrier film to then be dried.

An internal coil pattern may be formed on the insulating sheet (S200).

The internal coil pattern may be formed by applying a conductive paste containing a conductive metal to the insulating sheet through a printing method, or the like. As a printing method of the conductive paste, a screen printing method, a gravure printing method, or the like, may be used. However, the present disclosure is not limited thereto.

The conductive metal is not particularly limited as long as it is a metal having excellent electrical conductivity. For example, the conductive metal may be one of silver (Ag), palladium (Pd), aluminum (Al), nickel (Ni), titanium (Ti), gold (Au), copper (Cu), platinum (Pt), and the like, or a mixture thereof.

Vias may be formed in predetermined positions in the respective insulating layers having the internal coil patterns printed thereon, and the internal coil patterns on the respective insulating layers may be electrically connected to each other through the vias to thereby form the ceramic body 100 having a single internal coil part 200 (S300).

The first lead-out portion 210 and the second lead-out portion 220 of the internal coil part 200 formed as a single coil may be respectively exposed to both end surfaces of the ceramic body 100 in the length direction thereof.

Next, a marking pattern 500 may be formed on a top surface of the ceramic body 100 (S310). The exposed surfaces to which the first lead-out portion 210 and the second lead-out portion 220 of the internal coil part 200 are exposed may be identified by the marking pattern 500, and as a result, the ceramic body 100 may be aligned in a direction for forming a plating spreading part 400.

Meanwhile, a shape and a position of the marking pattern 500 are not limited to those shown in FIG. 6A.

Referring to FIG. 6B, an insulating layer 620 may be formed on a region in which the marking pattern 500 is not formed on the top surface of the ceramic body 100 (S320).

In addition, referring to FIG. 6C, an external electrode 300 may be formed on a bottom surface of the ceramic body 100 (S400). The external electrode 300 may be formed by using a conductive paste containing a metal having excellent electric conductivity. For example, the conductive paste may be a conductive paste containing, one of nickel (Ni), copper (Cu), tin (Sn), or silver (Ag), or the like, or an alloy thereof.

The first and second external electrodes 310 and 320 may be spaced apart from each other by a predetermined distance on the bottom surface of the ceramic body 100.

Next, an insulating layer 610 may be further formed on a region in which the first and second external electrodes 310 and 320 are not formed on the bottom surface of the ceramic body 100 (S410).

However, although the method of manufacturing a chip coil component according to an exemplary embodiment in the present disclosure is described with reference to FIGS. 6A through 6D and 7, the manufacturing method is not limited to the above-mentioned order. For example, before the marking pattern 500 is formed on the top surface of the ceramic body 100, the external electrode 300 may be first formed on the bottom surface of the ceramic body 100.

Next, referring FIG. 6E, a polishing process for a plurality of corners (a) disposed on both side surfaces of the ceramic body 100 in the width direction thereof may be performed (S420).

Next, the insulating layer may be applied to both side surfaces of the ceramic body 100 in the width direction thereof (S430). In addition, a grinding process for the respective first and second lead-out portions 210 and 220 exposed to both end surfaces of the ceramic body 100 in the length direction thereof may be performed (S440). In further detail, a coating layer removal for preventing foreign material and plating spreading may be performed.

Further, referring to FIG. 6F, after performing the coating layer removal for preventing the foreign material and plating spreading, the first lead-out portion 210 and the first external electrode 310 may be electrically connected to each other by plating. In an equal manner thereto, the second lead-out portion 220 and the second external electrode 320 may be electrically connected to each other by plating (S500).

Other features overlapped with those of the above-mentioned multilayer electronic component according to the foregoing exemplary embodiment in the present disclosure will be omitted.

As set forth above, according to exemplary embodiments in the present disclosure, the chip coil component and the method of manufacturing the same may reduce a plating spreading problem and may prevent short circuits between a metal can and an external electrode by applying an insulating layer to four surfaces of the body.

In addition, by an increase in volume of the body, direct current resistance and Ls characteristics may be improved.

While exemplary embodiments have been shown and described above, it will be apparent to those skilled in the art that modifications and variations could be made without departing from the scope of the invention as defined by the appended claims.

What is claimed is:

1. A chip coil component comprising:
a ceramic body including a plurality of insulating layers and having a bottom surface provided as amounting surface and a top surface opposing the bottom surface;
an internal coil part disposed in the ceramic body and having first and second lead-out portions exposed to end surfaces of the ceramic body in a length direction of the ceramic body;
an external electrode disposed on the bottom surface of the ceramic body; and
plating spreading parts formed on the end surfaces of the ceramic body in the length direction and connecting the first and second lead-out portions and the external electrode to each other.

2. The chip coil component of claim 1, wherein a length of the plating spreading part in a thickness direction of the ceramic body is longer than a length from the bottom surface of the ceramic body to the first or second lead-out portion and is shorter than a thickness of the ceramic body in a thickness direction of the ceramic body.

3. The chip coil component of claim 1, wherein the plating spreading part is formed using one or more selected from a group consisting of silver (Ag), platinum (Pt), copper (Cu), and palladium (Pd).

4. The chip coil component of claim 1, further comprising a marking pattern disposed on the top surface or the bottom surface of the ceramic body.

5. The chip coil component of claim 1, further comprising insulating layers disposed on regions in which the external electrode and the plating spreading part are not formed on the ceramic body.

6. A method of manufacturing a chip coil component, the method comprising:
preparing insulating sheets;
forming internal coil patterns on the insulating sheets;
forming a ceramic body including an internal coil part having a first lead-out portion and a second lead-out portion exposed to both end surfaces of the ceramic body in a length direction of the ceramic body by stacking the insulating sheets on which the internal coil patterns are formed and having a bottom surface provided as amounting surface and a top surface opposing the bottom surface;
forming an external electrode on the bottom surface of the ceramic body; and
connecting the first and second lead-out portions and the external electrode to each other by plating.

7. The method of claim 6, further comprising:
forming a marking pattern on the top surface of the ceramic body; and
forming an insulating layer on a region in which the marking pattern is not formed on a top surface of the insulating sheet.

8. The method of claim 6, further comprising forming an insulating layer on a region in which the external electrode is not formed on the bottom surface of the ceramic body.

9. The method of claim 6, further comprising:
polishing a plurality of corners disposed on both side surfaces of the ceramic body in the width direction;
forming insulating layers on both side surfaces of the ceramic body in the width direction; and
removing coating layers formed on the first and second lead-out portions.

10. The method of claim 6, wherein the external electrode is formed by using one of a printing method and a transferring method.

11. The method of claim 6, wherein in the connecting of the first and second lead-out portions and the external electrode to each other, a plating process is performed by using a plurality of conductive materials to form plating spreading parts disposed on both end surfaces of the ceramic body in the length direction.

12. The method of claim 11, further comprising additionally forming a plating film having a multilayer structure by further performing one or more kinds of plating on the plating spreading part.

13. The method of claim 11, wherein a length of the plating spreading part in a thickness direction of the ceramic body is longer than a length from the bottom surface of the ceramic body to the first or second lead-out portion and is shorter than a thickness of the ceramic body in the thickness direction.

14. The method of claim 11, wherein the plating spreading part is formed using one or more selected from a group consisting of silver (Ag), platinum (Pt), copper (Cu), and palladium (Pd).
